(19) United States
(12) Patent Application Publication
(10) Pub. No.: US 2002/0179369 A1
(43) Pub. Date: Dec. 5, 2002

(54) Mobile stand for hunters

(76) Inventor: Frank A. Wallace, Siloam Springs, AR (US)

Correspondence Address: Trent C. Keisling, HEAD, JOHNSON & KACHIGIAN, E.J. Ball Plaza, Suite 230, 112 West Center Street, Fayetteville, AR, 72701, US

(21) Appl. No.: 09/874,756

(22) Filed: Jun. 4, 2001

(51) Int. Cl. E06C 5/00

(52) U.S. Cl. 182/63.1; 182/127

(57) ABSTRACT

The present invention provides a mobile hunting stand that may be easily transported and quickly deployed. The present invention provides a stand that may be easily erected by the hunter while remaining on the ground and that also distributes the weight of the hunter and the stand upon the ATV rack. A base assembly pivotally supports a ladder assembly that supports an uppermost platform assembly. The base assembly includes a frame coupled to a spacer that is securely attached to a tree. The spacer includes an elongated brace with a hollow receiver at one end and a bracket at the opposite end with a webbing that extends outwardly from the bracket to be secured about the tree to secure the brace thereto. The receiver is adapted to be coupled to a hitch extending from the base assembly frame. The base assembly frame comprises variably spaced apart members. The ladder assembly is coupled pivotally to the base during deployment. The ladder assembly includes a plurality of elongated ladder sections that may be selectively coupled together to form a unitary elongated ladder to which the platform assembly may be secured. The platform assembly includes a generally parallelepiped superstructure upon which a hunter may sit. The superstructure includes a recessed or arcuate section adapted to at least partially receive a portion of the adjacent tree. Each ladder section may be coupled to a ramp section for loading and/or unloading the ATV.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention relates generally to mobile stands for hunters and the like. More particularly, the present invention involves a mobile stand that is transported by and mounted upon a conventional all-terrain vehicle or ATV. Known art may be found in U.S. class 182, subclass 116 and others.

2. Known Art

Those skilled in the art will appreciate that hunting often involves traversing rugged terrain in search of prey. In the relatively recent past, motorized all-terrain vehicles, commonly referred to as ATV's, have become indispensable transport vehicles for hunters and the like. Such conventional ATV's include 3-wheelers, 4-wheelers and the like. These motorized vehicles are generally capable of traversing very rugged terrain to transport hunters to remote areas and/or to retrieve game as well. Thus, many hunters find it desirable to utilize ATV's when hunting, especially when hunting large animals and/or in rugged, often remote terrain.

Those skilled in the art will also appreciate that many game types are most effectively hunted from above eye level and particularly in tree stands or the like. The known art including U.S. Pat. Nos. 3,282,375; 3,336,999; 4,408.680; 1,960,588; and 2,035,537 show hunting stands or ladder-like means used to place a person above the ground. While these devices work well for their intended purposes, they are not easily adapted to use with an ATV. Further, the transportation and deployment of these stands is often not without considerable effort and time. Thus, such stands do not function well with many modem hunting practices.

In particular, many lands with unrestricted access, such as those belonging to the government, have regulations and/or restrictions upon the use of tree stands or the like. Typically, the hunting rules for such lands prevent long-term or permanent installation of tree stands. Additionally, the theft of tree stands has become an increasing problem. Thus, it is often desirable for a hunter to place a stand in a location for only a single day or for short term hunting.

Attempts have been made to address this issue by the known art. For example, U.S. Pat. No. 4,625,831 shows a hunting stand pivotally mounted on the rack of an all-terrain vehicle. The stand comprises a pair of mounting brackets with a ladder having pivot points attached to the all-terrain vehicle. This device depends upon the all-terrain vehicle for support against a tree. This device, however does not provide a method for securing the stand to the tree, nor may the hunter easily position the device against a tree. Further, the device fails to provide a sufficient height to enable the hunter to achieve a desired level of concealment. Another problem is that the weight of the hunter and stand are not distributed upon the rack but are rather concentrated on a single section of the rack.

U.S. Pat. No. 4,800,986 shows a collapsible tower apparatus for use on an ATV. The tower apparatus includes a framework that is pivotally and reinforceably attached to the front and rear racks of the ATV. In use, a hunter climbs upon the tower and hunts from above the ATV. This device depends solely upon the ATV for support. Stability is therefore a concern with this device. Another problem with this device involves the inability to attain a sufficient height for the hunter to achieve a desired level of concealment.

U.S. Pat. No. 5,881,839 shows a hunter's stand which may be easily secured to the bed of a truck. This device may work well for its intended purpose but suffers from a lack of mobility associated with the conventional truck. Thus, this device is not well-suited to use in overly rugged terrain.

The known art fails to provide a safe hunting platform with a sufficient mobility to enable its effective deployment for short term hunts. Further, the known art fails to provide a sufficiently mobile stand that permits a hunter to attain a sufficient height to achieve a desired level of concealment. Thus, a need exists in the art for an improved mobile hunting stand that may be safely deployed upon an all-terrain vehicle.

The known art further fails to provide a mobile hunting stand for use on an all-terrain vehicle that sufficiently distributes a hunter's weight to the all-terrain vehicle in a manner that prevents damage to the all-terrain vehicle. Thus, a need exists in the art for such a device.

The known art also fails to provide a mobile hunting stand that may be safely deployed upon an all-terrain vehicle by a hunter remaining upon the ground. Thus, a need exists in the art for such a device.

### BRIEF SUMMARY OF THE INVENTION

The present invention provides a mobile hunting stand that may be easily transported and quickly deployed upon an all-terrain vehicle. The mobile hunting stand provides a safe and stable platform from which a hunter may effectively conceal his presence from his quarry. The present invention also provides a stand that may be easily erected by the hunter while remaining on the ground. The present invention also distributes the weight of the hunter and the stand upon the ATV rack.

The present invention includes a base assembly that supports a ladder assembly that supports an uppermost platform assembly. The base assembly further includes a spacer that is securely attached to a selected tree or other vertical object.

The spacer includes an elongated brace with a hollow receiver at one end and a bracket at the opposite end. A webbing extends outwardly from the bracket and the webbing is adapted to be secured about the tree or other vertical object to secure the brace thereto. The receiver is adapted to be coupled to a hitch extending from the base assembly frame.

The base assembly frame comprises a pair of spaced apart members coupled together by parallel and spaced apart shafts. The members may be variably spaced by the shafts.

The ladder assembly preferably includes a plurality of discrete ladder sections. The ladder assembly is coupled pivotally to the base during deployment. The ladder assembly includes a plurality of elongated ladder sections that may be selectively coupled together to form a unitary elongated ladder to which the platform assembly may be secured.

The platform assembly includes a generally parallel piped superstructure upon which a hunter may sit. The superstructure includes a recessed or arcuate section adapted to at least partially receive a portion of the adjacent tree or other vertical object.

In use, the user preferably transports the 4-wheeler to the hunting area in a conventional trailer with a draft vehicle or in a conventional truck or the like since in many locales it is illegal to drive all-terrain vehicles on the roads. Once in the hunting area, the user then deploys the all-terrain vehicle in a customary fashion. In one exemplary embodiment, the ladder sections may be optionally used as a loading/unloading ramp for the all-terrain vehicle.

The mobile stand is packed unassembled upon the all-terrain vehicle for transport to a desired hunting site. Once at the hunting site, the user then deploys the stand in a desired configuration. The user may select from a configuration where the stand is mounted upon the all-terrain vehicle or upon the ground. In the preferred embodiment, the stand is mounted adjacent a tree or other vertical object.

To deploy the stand, the user first deploys the base assembly. When using an all-terrain vehicle, the base assembly is secured to the rear rack of the all-terrain vehicle. When deployed upon the ground, the base assembly is simply placed upon the ground. The brace of the base assembly is then secured to the tree by placing the bracket against the tree and encircling the tree with the webbing. The webbing is then securely affixed to the tree. This immobilizes the base assembly relative to the tree.

The ladder assembly is next coupled to the base assembly piece by piece. The user first inserts a ladder section onto the upwardly protruding pivoting rods of the base assembly. The user may then pivot the ladder assembly over the front of the all-terrain vehicle or onto the ground for further assembly. After all ladder sections have been coupled onto the base assembly, the user inserts the terminal platform assembly.

After the ladder assembly is fully assembled and attached to the base assembly, the user pivots it into place. The user may pivot the ladder assembly by simply raising the terminal section until it is adjacent the tree. The user then leans the ladder assembly and particularly the platform assembly against the tree. The user then secures the platform assembly to the tree with a second webbing in a fashion similar to the base webbing. If desired, the all-terrain vehicle may be suitably camouflaged as well. The stand is ready for subsequent use by the hunter.

Thus, an object of the present invention is to provide an improved mobile stand.

Another object of the present invention is to provide a mobile stand that may be easily transported to a selected locale and assembled by a single person.

Another object of the present invention is to provide a mobile stand that may be deployed with either a conventional all-terrain vehicle or upon the ground.

Another object of the present invention is to provide an elevated platform that is stable.

Yet another object of the present invention is to provide a mobile stand that may be assembled by a user remaining on the ground.

Another object of the present invention is to provide a mobile stand that may be placed at a selected height to achieve a desired level of concealment.

An object of the present invention is to provide a stand that may be used to load or unload an all-terrain vehicle into a transport vehicle.

A basic object of the present invention is to provide an improved stand for hunters.

Another object of the present invention is to provide an improved stand that distributes a load over substantially its entire support surface.

### BRIEF DESCRIPTION OF THE SEVERAL VIEWS OF THE DRAWING

FIG. 1 is a side elevational view showing an exemplary embodiment of the mobile stand for hunters of the present invention, with the dash line showing a move position of the invention;

FIG. 2 is a top plan view thereof;

FIG. 3 is a partially exploded side elevational view thereof;

FIG. 4 is a partially exploded top plan view thereof;

FIG. 5 is an enlarged view of the encircled portion of FIG. 1;

FIG. 6 is an enlarged view of the encircled portion of FIG. 4;

FIG. 7 is a top plan view of the base assembly;

FIG. 8 is a rear elevational view thereof;

FIG. 9 is a side elevational view thereof, with the opposite side being a mere image;

FIG. 10 is a front elevational view thereof;

FIG. 11 is a bottom plan view thereof;

FIG. 12 is a side elevational view of the spacing assembly;

FIG. 13 is a front elevational view thereof;

FIG. 14 is a rear elevational view thereof;

FIG. 15 is a top plan view thereof;

FIG. 16 is a side elevational view of a ladder section;

FIG. 17 is a bottom plan view thereof;

FIG. 18 is a top plan view thereof;

FIG. 19 is a top plan view of the platform assembly;

FIG. 20 is a side elevational view thereof with the opposite side being a mere image;

FIG. 21 is a bottom plan view thereof;

FIG. 22 is a partially exploded side elevational view showing the invention deployed as a ramp for loading an ATV into a transport vehicle;

FIG. 23 is a top plan view of an upper ramp attachment;

FIG. 24 is a side elevational view thereof, with the opposite side being a mirror image;

FIG. 25 is a bottom plan view thereof;

FIG. 26 is a front elevational view thereof;

FIG. 27 is a rear elevational view thereof;

FIG. 28 is a top plan view of a lower ramp attachment;

FIG. 29 is a side elevational view thereof, with the opposite side being a mirror image;

FIG. 30 is a side elevational view of the invention deployed directly upon the ground; and,

FIG. 31 is a side elevational view of a second exemplary embodiment of the invention.

### DETAILED DESCRIPTION OF THE INVENTION

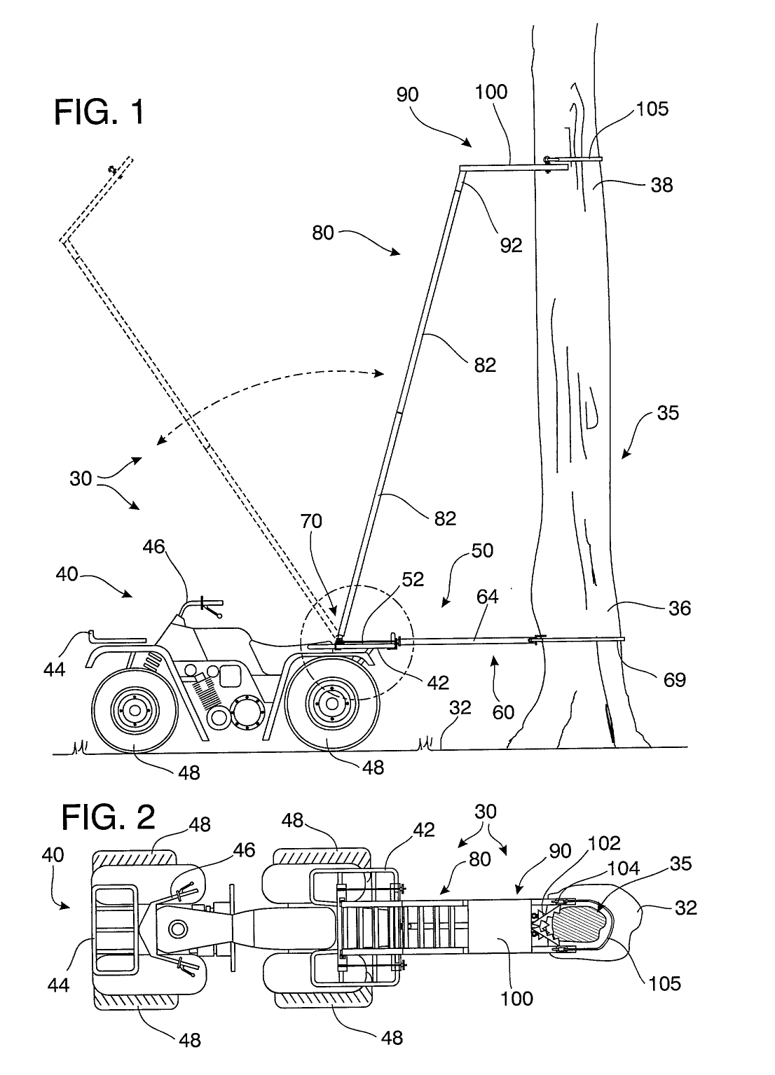

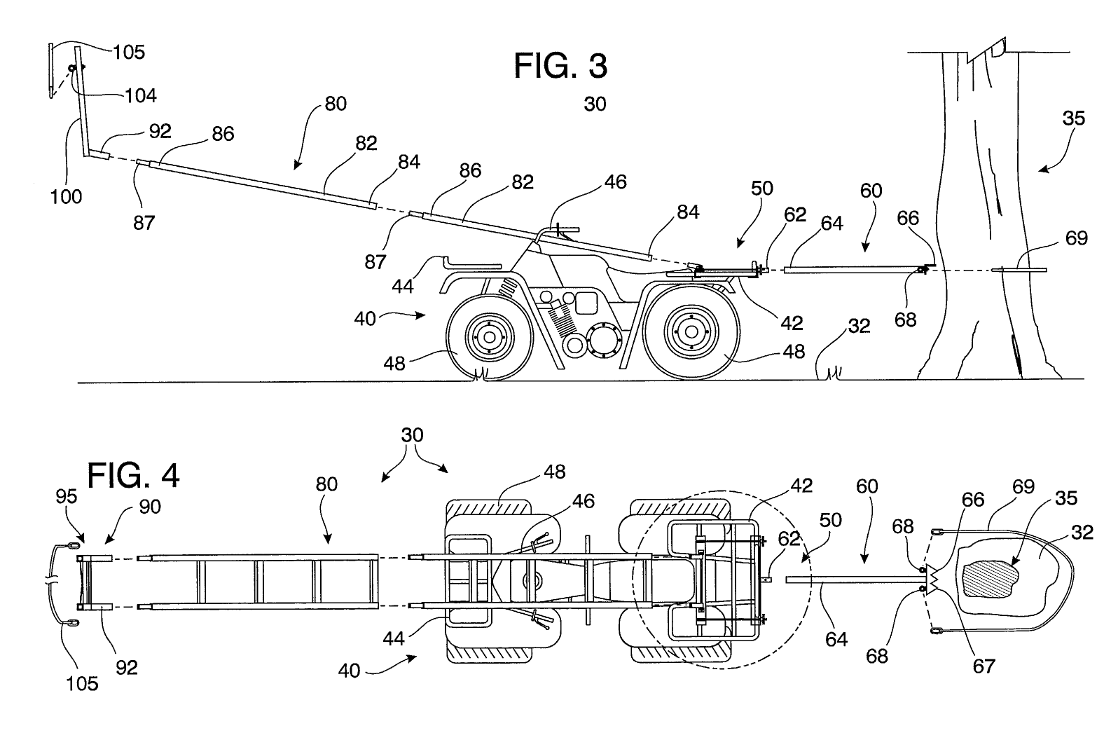

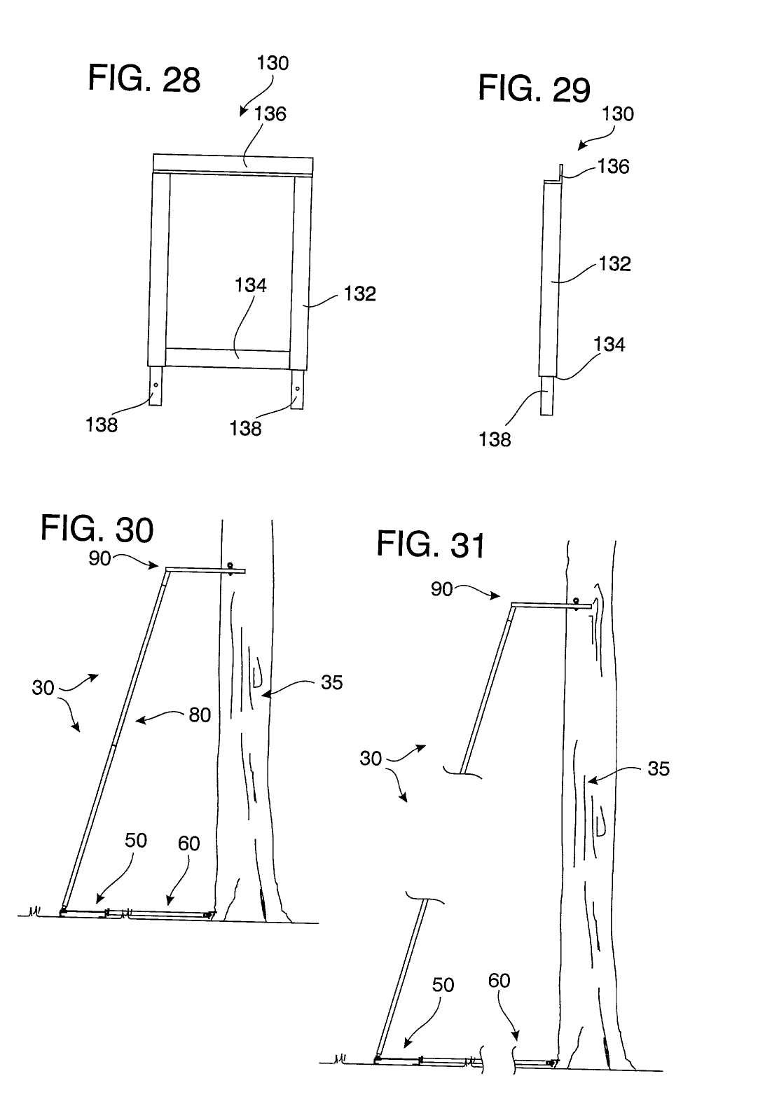

The mobile hunting stand of the present invention is generally designated by reference numeral 30 in FIGS. 1-29. The mobile hunting stand may be preferentially deployed adjacent a tree 35 or other similar vertical object extending upwardly from the ground 32. The mobile hunting stand 30 is also preferentially employed with an all-terrain vehicle or ATV, such as conventional 4-wheeler 40. The primary requisite for the ATV is that it have a rear rack 42 to which the hunting stand may be securely coupled. Most conventional ATV's also include a front rack 44, steering handlebars 46 and several wheels 48.

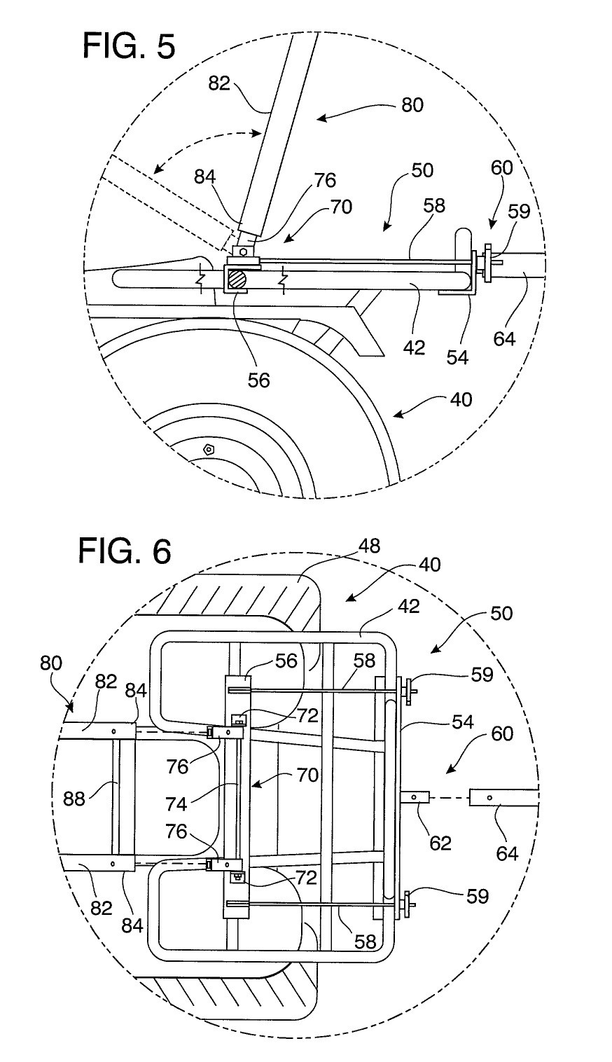

The hunting stand 30 includes a base assembly 50 that couples directly to the rear rack 42. The base assembly 50 pivotally supports an elongated ladder assembly 70 (FIGS. 1 and 5). The ladder assembly 70 supports an uppermost platform assembly 90 (FIGS. 1-5).

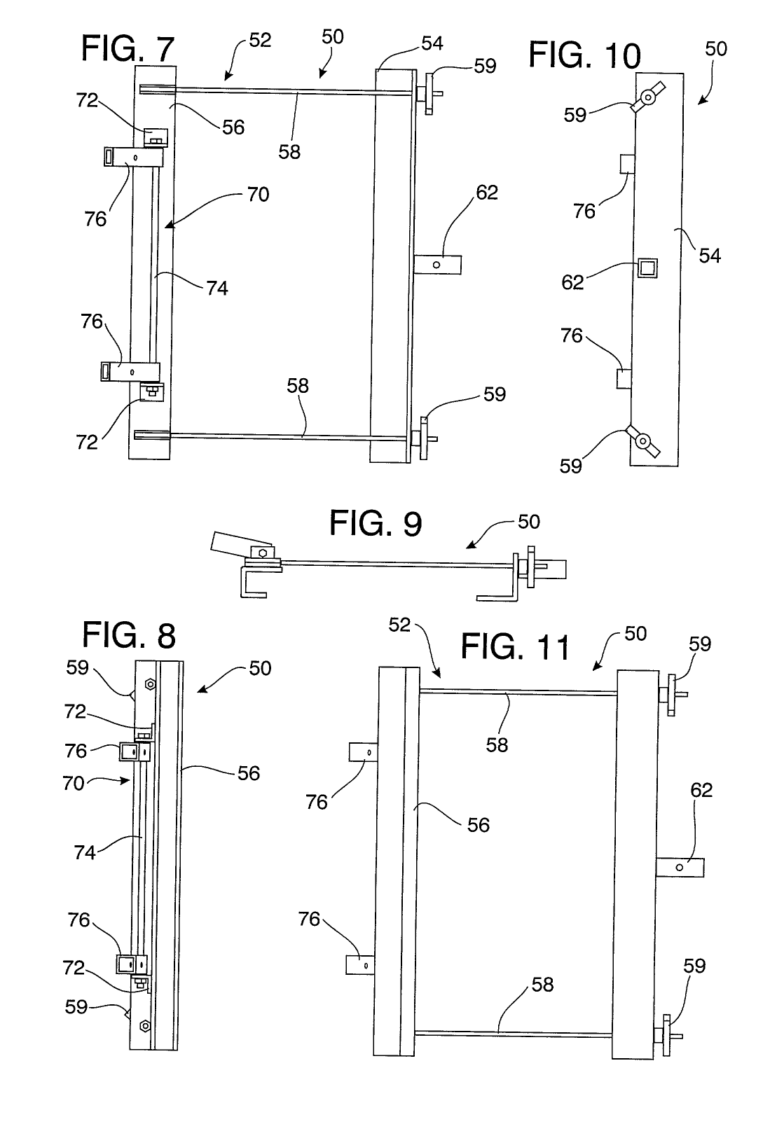

The base assembly 50 pivotally supports the ladder assembly 70 and uppermost platform assembly 90. The base assembly includes a generally parallelepiped frame 52 (FIGS. 7-11). The frame 52 includes a front member 54 and a rear member 56 variably spaced apart by two threaded rods 58 with wingnuts 59.

Front member 54 preferably captivates a substantial portion of the ATV rear rack 42 and ideally the rear members thereof. Front member 54 also couples the base assembly 50 to the spacing assembly 60.

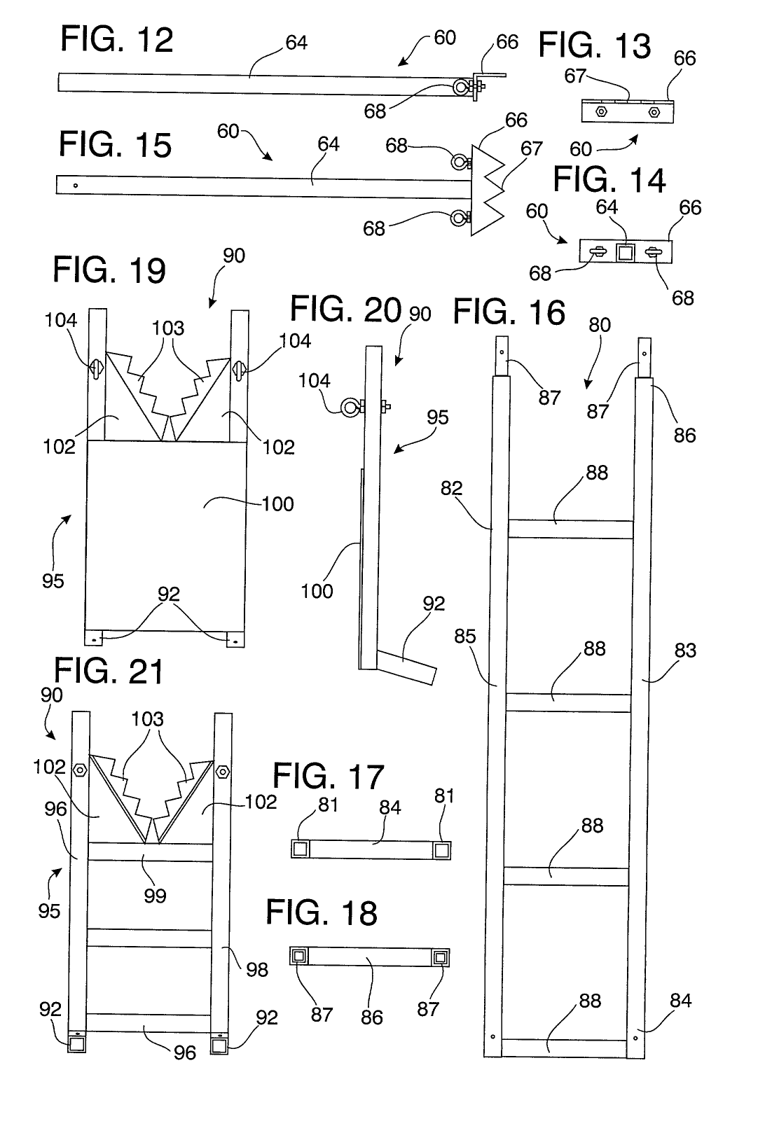

The spacing assembly 60 secures to a protruding tab 62 integrally secured to the front member 54 (FIGS. 12-15). The tab 62 inserts into a hollow elongated brace 64. A pin or other similar device may be inserted through both the tab 62 and brace 64 in aligned holes to secure the brace to the tab. The brace is ideally 2 to 4 feet in length. The brace spaces the ATV 40 an appropriate distance from tree 35. The spacer 60 includes the brace 64 which supports a bracket 66. Bracket 66 has several engagement teeth 67. Engagement teeth 67 are adapted to secure the bracket 66 to the tree 35. The bracket 66 also includes eyelets 68 to which an elongated webbing 69 may be secured. In use, the webbing 69 is looped about the tree 35 and secured to the eyelet 68 to fixedly secure the spacer 60 to the tree 35.

The rear member 56 is preferentially formed of C-channel or the like captivate a portion of the rear rack 42 (FIGS. 7-11). Rear member 56 ideally measures between 12 inches and 36 inches so as to captivate a substantial portion of a lateral span in rear rack 42. Ideally rear member 56 also captivates at least one and preferably two reinforcing bars of the rear rack 42. Rear member 56 also supports a pivoting mount assembly 70 for the ladder section 80.

The pivoting assembly 70 includes spaced apart set-offs 72 integrally mounted to rear member 56. The set-offs 72 are penetrated by an axle 74. Axle 74 also penetrates pivoting tabs 76 adjacent each of the set-off 72. The pivoting tabs 76 are inserted into a first ladder section 82 to support the ladder assembly 80 and uppermost platform assembly 90 to the base assembly 50.

The ladder assembly 80 preferably includes a plurality of identical ladder sections 82 that may be coupled together to form a unitary ladder (FIGS. 16-18). The section 82 has spaced apart ends 84 and 86. The ladder section 82 includes parallel elongated legs 83 and 85 separated by a plurality of rungs 88. Each leg 83, 85 has a hollow receiver 81 adjacent end 84 and a protruding stinger 87 adjacent end 86. The ladder assembly 80 may utilize a plurality of ladder sections 82 in order to achieve a desired height for ladder assembly 80. Preferably, each ladder section 82 is approximately 3 ft. in length although longer or shorter dimensions may be utilized as desirable. Conventional pins are inserted through aligned holes in respective receivers 81 and stingers 87 to couple successive ladder sections together. Conventional pins are also utilized to couple the receivers 81 to the set offs 76 of the base assembly 50.

The ladder assembly 80 supports an uppermost platform assembly 90 (FIGS. 19-21). The platform assembly 90 includes receivers 92 that are adapted to be secured with a pin to ladder stingers 87. The receivers 92 are integrally secured to a generally parallelepiped superstructure 95. Superstructure 95 includes parallel support members 96 and 98 with supporting braces 99 extending therebetween. The supporting braces 99 and members 96, 98 support a hunting platform 100. Platform 100 preferably has a rectangular outline that is approximately 2 ft. by 3 ft.

The platform assembly 90 also includes angled tree anchors 102 adjacent platform 100. Each anchor 102 includes a plurality of protruding teeth 103. Eyelets 104 penetrate members 96, 98 adjacent receivers 102. An elongated webbing 105 may be strung between eyelets 104 and about tree 35 at an upper level 38, similarly to the attachment of webbing 69 about lower portion 36.

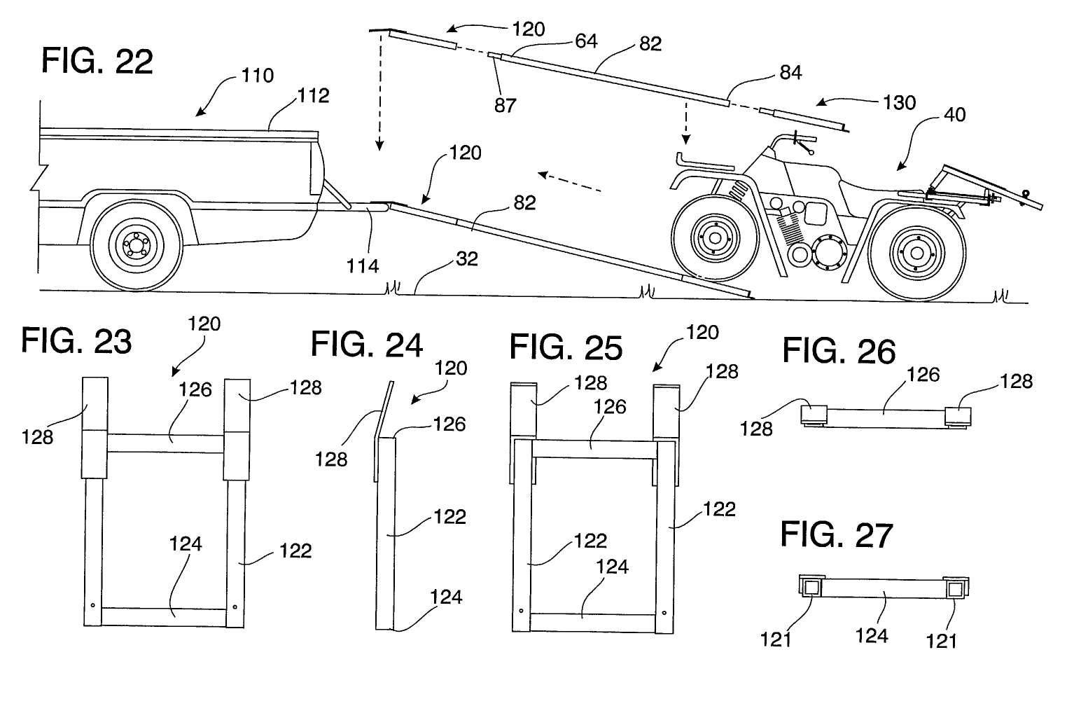

In use, the ladder assembly 80 may be coupled to an upper ramp assembly 120 and lower ramp assembly 130 for the unloading and/or unloading of an ATV in a conventional transport vehicle 110 with an open transport area 112 and a pivoting access such as tailgate 114 (FIGS. 22-29). The upper ramp assembly 120 includes a pair of parallel legs 122 with spaced apart ends 124 and 126. Ideally, end 124 includes hollow receivers 121 adapted to be inserted upon ladder stingers 87. End 126 includes arcuate arms 128 adapted to be placed upon tailgate 114. The lower ramp assembly 130 includes a pair of parallel legs 132 with spaced apart ends 134 and 136. Ideally, end 134 includes stingers 138 that may be inserted into ladder end 84. End 136 is angled to dig into the ground to secure the assembly against the transport vehicle. When the ladder assembly is so deployed, the user may easily unload or load the ATV from the conventional transport vehicle.

During transport, the user places the unassembled components of stand 30, including the base assembly 50 the ladder assembly 80 and the platform assembly 90 upon the rear rack 42 of the ATV 40. The user may also utilize the front rack 46 as well. The user then transports the stand 30 to a desired hunting site for deployment.

At the hunting site, the user removes the unassembled ladder assembly and platform assembly from the 4-wheeler rack 42 (FIGS. 1-6). The base assembly remains secured to the rear rack 42 or it is secured to the rack 42 at this time. The base assembly is secured to the rack 42 by captivating a front portion of the rack and a rearmost portion of the rack 42 between front and rear members 54 and 56. The user then secures the respective front and rear members by tightening the nuts 59 on rods 58 until the base assembly 50 is secured to the rear rack 42. Ideally, the base assembly captivates a substantial portion of the rack 42 so that the combined weight of the stand 30 and hunter are distributed across the captivated rack portion to prevent damage thereto.

The user next places set offs 76 in a forward assembly orientation so that they are pointd at handlebars 46. The user may then assemble the components of stand 30 in this assembly position. The user inserts a first ladder section 82 and particularly receivers 84 over set-offs 76. Additional ladder sections 82 are inserted upon stingers 87 to attain a desired height. In one exemplary embodiment, two ladder sections 82 are utilized although more could be utilized as desired.

The user then secures platform assembly 90 to the ladder assembly 80 by inserting receivers 92 upon stingers 87.

The user secures receivers 84 to set-offs 67 by using conventional pins inserted through aligned holes in receivers 84 and set-offs 67. The user secures adjoining ladder sections by inserting a conventional pin through aligned holes in receivers 84 and stingers 87. The user secures platform assembly 90 to ladder assembly 80 by inserting a pin through aligned holes in receivers 92 and stingers 87.

The user may support ladder assembly 80 over front handlebars 46 during assembly. Once the ladder assembly 80 and platform assembly 90 have been secured to the base assembly 50 in the lowered assembly position, the user may pivot the ladder assembly 80 and platform assembly 90 into an upright position adjacent tree 35 while remaining upon ground 32.

In some situations, it may be desirable to deploy stand 30 directly upon the ground 32. In such situations, the base assembly 50 is deployed directly upon ground 32 instead of rear rack 42 (FIG. 30). In another exemplary embodiment, the ladder assembly 80 is comprised of a plurality of ladder sections 82 and the spacing assembly 60 and particularly brace 64 may be telescopic or otherwise extensible (FIG. 31).

### SEQUENCE LISTING

Not Applicable.

What is claimed is:

1. A mobile hunting stand adapted to be placed against a tree or other vertical object extending upwardly from the ground, said stand comprising:
a base assembly adapted to be placed upon a supporting surface in proximity to the vertical object, said base assembly comprising a parallelepiped frame coupled to an elongated spacer adapted to be secured to the object in proximity to the ground;
an elongated ladder assembly adapted to be pivotally coupled to said base assembly, said ladder assembly including a plurality of discrete sections adapted to be secured together to form a unitary assembly; and,
a platform assembly adapted to be placed upon said unitary ladder assembly during deployment by a user, said platform assembly including means for securing said platform to an upper section of said object.

2. The stand as recited in claim 1 wherein said base assembly includes a front member and a spaced apart rear member and wherein said base assembly is adapted to be deployed upon the rear rack of an all-terrain vehicle.

3. The stand as recited in claim 2 wherein said base assembly distributes the weight of the stand and the user across a substantial portion of said rack.

4. The stand as recited in claim 3 wherein said front and rear members are variably spaced by threaded rods and wherein said rods are secured to said rear member and penetrate said front member and wherein a nut is secured about each of said rods and adapted to variably displace said front member relative to said rear member.

5. The stand as recited in claim 4 wherein said rear member includes at least two spaced apart pivoting set offs adapted to support said ladder assembly.

6. The stand as recited in claim 1 wherein said spacer further includes an elongated webbing adapted to be placed around the object to secure said base assembly thereto.

7. The stand as recited in claim 1 wherein said platform assembly further includes an elongated webbing adapted to be placed about the object adjacent said platform when said stand is deployed.

8. A mobile hunting stand for use with an all-terrain vehicle with a rear rack and adapted to be placed against a tree or other vertical object extending upwardly from the ground, said stand comprising:
a base assembly adapted to be placed upon a supporting surface in proximity to the vertical object, said base assembly comprising a parallelepiped frame having a front member and a spaced apart rear member and wherein said frame is adapted to be deployed upon the rear rack of an all-terrain vehicle, and said front member is coupled to an elongated spacer adapted to be secured to the object in proximity to the ground;
an elongated ladder assembly adapted to be pivotally coupled to said base assembly, said ladder assembly including a plurality of discrete sections adapted to be secured together to form a unitary assembly; and,
a platform assembly adapted to be placed upon said unitary ladder assembly during deployment by a user, said platform assembly including means for securing said platform to an upper section of said object.

9. The stand as recited in claim 8 wherein said base assembly distributes the weight of the stand and the user across a substantial portion of the rack.

10. The stand as recited in claim 8 wherein said front and rear members are variably spaced by threaded rods and wherein said rods are secured to said rear member and penetrate said front member and wherein a nut is secured about each of said rods and adapted to variably displace said front member relative to said rear member.

11. The stand as recited in claim 8 wherein said rear member includes at least two spaced apart pivoting set offs adapted to support said ladder assembly.

12. The stand as recited in claim 8 wherein said spacer further includes an elongated webbing adapted to be placed around the object to secure said base assembly thereto.

13. The stand as recited in claim 12 wherein said platform assembly further includes an elongated webbing adapted to be placed about the object adjacent said platform when said stand is deployed.

14. The stand as recited in claim 8 wherein said base assembly, ladder assembly and platform assembly are secured during transport to the rear rack of the all-terrain vehicle and first assembled at a selected hunting site by a hunter in a lowered assembly position and then pivoted into an upright deployed position adjacent the object by the hunter while remaining upon the ground.

15. A mobile hunting stand adapted to be transported by an all-terrain vehicle with a rear rack to a desired hunting site with a tree, said stand comprising:
a base assembly adapted to be placed upon the rear rack in proximity to the tree, said base assembly comprising a parallelepiped frame having a front member and a spaced apart rear member and wherein said frame is adapted to be deployed upon the rear rack of an allterrain vehicle, and said front member is coupled to an elongated spacer adapted to be secured to the object in proximity to the ground;
an elongated ladder assembly adapted to be pivotally coupled to said base assembly, said ladder assembly including a plurality of discrete sections adapted to be secured together to form a unitary assembly;
a platform assembly adapted to be placed upon said unitary ladder assembly during deployment by a user, said platform assembly including means for securing said platform to an upper section of said object;
wherein said base assembly, ladder assembly and platform assembly are secured during transport to the rear rack and then first assembled at a selected hunting site by a hunter in a lowered assembly position and then pivoted into an upright deployed position adjacent the object by the hunter while remaining upon the ground; and,
wherein said base assembly distributes the weight of the stand and the user across a substantial portion of the rack.

16. The stand as recited in claim 15 wherein said front and rear members are variably spaced by threaded rods and wherein said rods are secured to said rear member and penetrate said front member and wherein a nut is secured about each of said rods and adapted to variably displace said front member relative to said rear member.

17. The stand as recited in claim 15 wherein said rear member includes at least two spaced apart pivoting set-offs adapted to support said ladder assembly.

18. The stand as recited in claim 15 wherein said spacer further includes an elongated webbing adapted to be placed around the object to secure said base assembly thereto.

19. The stand as recited in claim 15 wherein said platform assembly further includes an elongated webbing adapted to be placed about the object adjacent said platform when said stand is deployed.

20. A mobile hunting stand for use with an all-terrain vehicle with a rear rack adapted to be placed against a tree or other vertical object extending upwardly from the ground, said stand comprising:
a base assembly adapted to be placed upon the rack of the all-terrain vehicle in proximity to the vertical object, said base assembly comprising a parallelepiped frame having a front member and a spaced apart rear member and wherein frame is mounted upon the rear rack of an all-terrain vehicle, said front and rear members are variably spaced by threaded rods and wherein said rods are secured to said rear member and penetrate said front member and wherein a nut is secured about each of said rods and adapted to variably displace said front member relative to said rear member and said rear member includes at least two spaced apart pivoting set-offs, and said front member is coupled to an elongated spacer adapted to be secured to the object in proximity to the ground;
an elongated ladder assembly adapted to be pivotally coupled to said base assembly, said ladder assembly including a plurality of discrete sections adapted to be secured together to form a unitary assembly;
a platform assembly adapted to be placed upon said unitary ladder assembly during deployment by a user, said platform assembly including means for securing said platform to an upper section of said object;
wherein said base assembly, ladder assembly and platform assembly are secured during transport to the rear rack and then first assembled at a selected hunting site by a hunter in a lowered assembly position and then pivoted into an upright deployed position adjacent the object by the hunter while remaining upon the ground; and,
wherein said base assembly distributes the weight of the stand and the user across a substantial portion of said rack.

21. The stand as recited in claim 20 wherein said spacer further includes an elongated webbing adapted to be placed around the object to secure said base assembly thereto.

22. The stand as recited in claim 20 wherein said platform assembly further includes an elongated webbing adapted to be placed about the object adjacent said platform when said stand is deployed.
